(19) United States
(12) Patent Application Publication
(10) Pub. No.: US 2008/0269997 A1
(43) Pub. Date: Oct. 30, 2008

(54) Automatic Brake Control Device

(76) Inventors: Toshiki Ezoe, Tokyo (JP); Shuji Narada, Tokyo (JP); Naoshi Ichinose, Tokyo (JP); Koichi Okamoto, Tokyo (JP); Hirokazu Okuyama, Tokyo (JP)

Correspondence Address: VON SIMSON & CHIN, 62 WILLIAM STREET, 6TH FLOOR, NEW YORK, NY, 10005, US

(21) Appl. No.: 12/064,586

(22) PCT Filed: Aug. 8, 2006
(86) PCT No.: PCT/JP2006/315644

§ 371 Date: Feb. 22, 2008

(30) Foreign Application Priority Data
Aug. 24, 2005 (JP) 2005-242047
Aug. 24, 2005 (JP) 2005-242060
Aug. 24, 2005 (JP) 2005-242127
Oct. 28, 2005 (JP) 2005-314588
Jan. 27, 2006 (JP) 2006-019315

(51) Int. Cl. B60T 8/171

(52) U.S. Cl. 701/70

(57) ABSTRACT

A stepwise brake control is automatically performed when TTC obtained according to a relative distance and a relative speed between a vehicle and an object is lower than a predetermined value. For example, a brake force or a brake reduction speed is gradually increased over a plurality of stages in time series. Moreover, a brake force or a brake reduction speed change ratio in the section from the rise point of a brake force or a brake reduction speed at each stage to a predetermined brake force or a brake reduction speed is made a predetermined value or a change process is made a change process along a curved shape defined by a predetermined function. Moreover, at the initial stage when gradually increasing the brake force or the brake reduction speed, an auxiliary brake is used. Alternatively, a caution stage having a brake force or a brake reduction speed smaller that the initial stage is provided at the stage preceding the first stage of the plurality of stages, so that the auxiliary brake is used at this caution stage.

### TECHNICAL FIELD

The present invention is utilized for a heavy vehicle (truck, bus) for transporting cargos and passengers.

### BACKGROUND ART

An electronic control tendency of an automobile gets ahead quickly, and an event which previously depended upon a driver's judgment is also controlled by a computer loaded on a vehicle.

As one example, there is an automatic brake control device in which a distance between a subject vehicle and a vehicle ahead (distance between the vehicles) is monitored by a radar, and when the distance between the vehicles becomes abnormally short, brake control is performed automatically, and when collision occurs, damage is suppressed to a small level (see patent document 1 for example).

Patent Document 1: JP2005-31967A

### DISCLOSURE OF THE INVENTION

### Problem to be Solved by the Invention

The above-described automatic brake control device is becoming commercially practical for a passenger vehicle, but when attempt is made to utilize the same function for a heavy vehicle (truck, bus) for transporting cargos or passengers, there are problems which must be solved.

That is, the heavy vehicle has extremely large mass as compared with a passenger vehicle, it is necessary to secure safety for the passengers or cargos in addition to safety for a driver himself or herself, it is difficult to achieve the intended purpose only by simple abrupt brake control which is carried out in an automatic brake control of a passenger vehicle, and it is necessary to perform more precise automatic brake control as compared with the passenger vehicle. However, since such means is not established, an automatic brake control device for a truck or a bus has not yet become commercially practical.

The present invention has been accomplished under such background, and it is an object of the invention to provide an automatic brake control device capable of realizing the automatic brake control in a truck and a bus.

### Means for Solving the Problems

The present invention provides an automatic brake control device including control means which automatically performs brake control based on a sensor output including a distance between a subject vehicle and an object existing ahead the subject vehicle even if there is no driving operation.

The present invention is characterized in that the control means includes stepwise brake control means which automatically performs stepwise brake control when an estimated value of time elapsed until a distance between the object and the subject vehicle derived based on a relative distance and a relative speed of the object and the subject vehicle obtained by the sensor output becomes equal to or smaller than a predetermined distance becomes less than a predetermined value.

The estimated value of time elapsed until a distance between the object and the subject vehicle derived based on the relative distance and relative speed of the object and the subject vehicle becomes equal to or less than the predetermined distance is an estimated value of time elapsed until the object and the subject vehicle collide against each other (TTC (Time To Collision), hereinafter).

The stepwise brake control means includes the brake control means which gradually increases the brake force or brake reduction speed over the plurality of stages in time series.

The brake force or the brake reduction speed is gradually increased in this manner instead of using the maximum brake force or brake reduction speed abruptly. With this, it is possible to bring the brake pattern to that of a normal driver of a truck and a bus, and it is possible to decelerate the vehicle speed while maintaining the safety of the vehicle. With this, it is possible to moderate the impact at the time of collision while maintaining the safety also in a heavy vehicle such as the truck and bus.

In the invention, the stepwise brake control means includes means which sets, to a predetermined value, a change ratio of the brake force or a brake reduction speed in a section from a rising point of the brake force or the brake reduction speed of each stage to a point in which intended brake force or brake reduction speed is achieved.

That is, according to the invention, when stepwise brake control is performed, it is possible to set, to a predetermined value, a change ratio of the brake force or a brake reduction speed in a section from a rising point of the brake force or the brake reduction speed of each stage to a point in which intended brake force or brake reduction speed is achieved. With this, it is possible to prevent sudden braking from being applied, and to keep the safety of the vehicle.

Alternately, the stepwise brake control means includes means which brings, into variation process along a curve shape defined by a predetermined function, a variation process of a brake force or brake reduction speed in a section from a rising point of the brake force or the brake reduction speed of each stage to a point in which intended brake force or brake reduction speed is achieved. With this, the change ratio of the brake force or brake reduction speed can be smoothened as compared with the former case.

In the invention, the stepwise brake control means includes means which generates a brake force by an auxiliary brake in a stage where the brake force or the brake reduction speed is equal to or less than a predetermined value.

That is, when stepwise automatic brake control is performed, in the initial stage where large abrupt brake force or brake reduction speed is not required, a brake force is generated using the auxiliary brake. With this a load on the main brake such as a disk brake can be reduced.

In the invention, the stepwise brake control means includes a caution stage having a brake force or a brake reduction speed smaller than that of the initial stage, and the stepwise brake control means can be provided with the caution stage at its stage forward than the initial stage of the plurality of stages. In the caution stage, brake is executed using the auxiliary brake.

Generally, a brake force of the auxiliary brake is weak (e.g., 0.03 G to 0.5 G), it is possible to avoid sudden deceleration from the initial stage of the automatic brake control, and to ensure the safety with respect to a vehicle behind.

That is, a brake force of an auxiliary brake is weak and sudden deceleration is not caused. Utilizing this fact, the automatic brake control is actuated from an early stage when TTC has sufficient margin, and it is possible to urge a driver to pay attention. That is, since the auxiliary brake is operated, a driver hears a sound emitting from the auxiliary brake itself, a sound emitting from the engine because the engine revolution number is reduced, or an alarm sound informing the driver of the fact that the automatic brake control is actuated, recognizes that the automatic brake control is actuated by feeling the deceleration, and can pay attention to the leading vehicle.

Also, the automatic brake control device can include means which prohibits actuation of the stepwise brake control means when the subject vehicle speed is less than a predetermined value and a value of the steering angle or a yaw rate is out of a predetermined range.

That is, the stepwise brake control performed by the automatic brake control device of the present invention is assumed to be used in such a state where the vehicle speed before the brake control is started is 60 km/h or greater and large steering operation such as changing of lane or running on a sharp curve is not carried out. Therefore, it is possible to limit the actuation of the stepwise brake control in other running state.

For example, if the vehicle speed before the brake control is started is less than 60 km/h, since kinetic energy of the vehicle is small, no problem is caused even if simple abrupt brake control is carried out which is conventionally applied to a passenger vehicle and thus, the actuation of the stepwise brake control is limited. For example, if the steering angle before the brake control is started is +30 degrees or greater or −30 degrees or less, this means that the vehicle is changing lane or running on a sharp curve, this is out of condition for applying the stepwise brake control, and thus, actuation of the stepwise brake control is limited. In this case, a yaw rate may be used instead of the steering angle.

### Effect of the Invention

According to the present invention, it is possible to realize an automatic brake control for a truck and a bus. By using the auxiliary brake for the automatic brake control, it is possible to reduce a load applied to a main brake such as a disk brake. By providing a caution stage, high safety can be secured.

### BRIEF DESCRIPTION OF THE DRAWINGS

FIG. 1 is a configuration diagram of a control system according to a first embodiment;

FIG. 2 is a flowchart showing operation of a brake control ECU according to an embodiment of a first invention;

FIG. 3 are diagrams showing brake patterns of the brake control ECU of the first embodiment at the time of no-load;

FIG. 4 are diagrams showing brake patterns of the brake control ECU of the first embodiment at the time of semi-load;

FIG. 5 are diagrams showing brake patterns of the brake control ECU of the first embodiment at the time of constant-load;

FIG. 6 is a diagram showing a brake pattern of the brake control ECU of the first embodiment at the time of full-scale;

FIG. 7 is a diagram for explaining a brake force change ratio in a brake pattern of a second embodiment;

FIG. 8 is a diagram for explaining a brake force change curve in a brake pattern of a third embodiment;

FIG. 9 is a configuration diagram of a control system according to fourth and fifth embodiments;

FIG. 10 is a flowchart showing control procedure of a brake control ECU of the fifth embodiment;

FIG. 11 are diagrams showing brake patterns of the brake control ECU of the fifth embodiment at the time of no-load;

FIG. 12 are diagrams showing brake patterns of the brake control ECU of the fifth embodiment at the time of semi-load; and

FIG. 13 are diagrams showing brake patterns of the brake control ECU of the fifth embodiment at the time of constant-load.

### DESCRIPTION OF REFERENCE NUMERALS

1 millimeter wave radar
2 steering sensor
3 yaw rate sensor
4 brake control ECU
5 gateway ECU
6 meter ECU
7 Vehicle CAN
8 engine ECU
9 axle load scale
10 EBS_ECU
11 brake actuator
12 engine
13 vehicle speed sensor
14 auxiliary brake ECU
15 auxiliary brake
40 brake pattern selecting portion
41 brake pattern storing portion

### BEST MODE FOR CARRYING OUT THE INVENTION

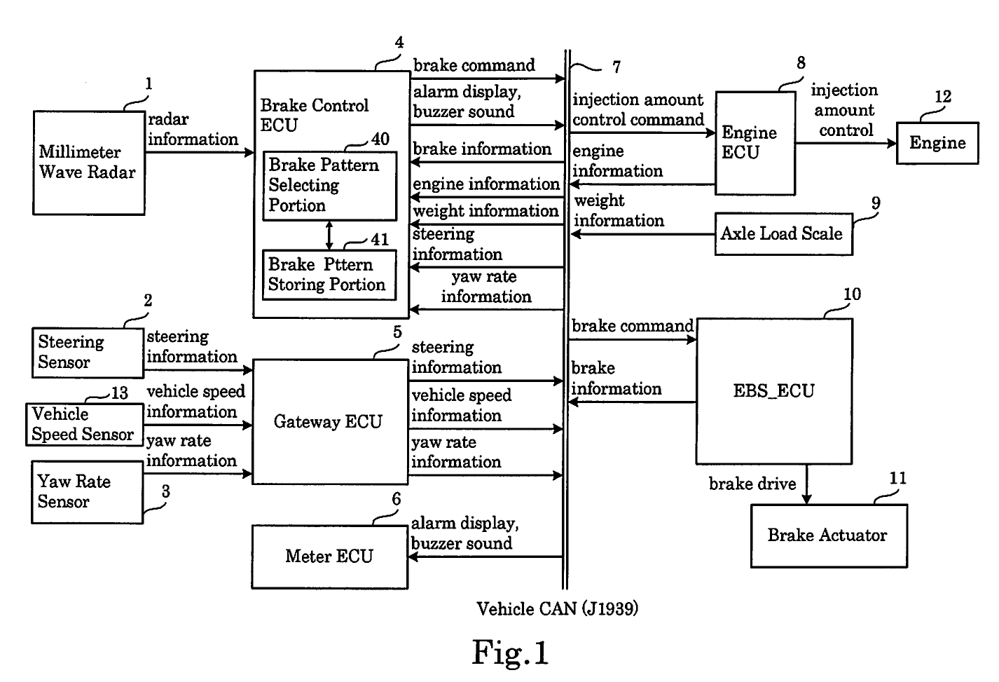

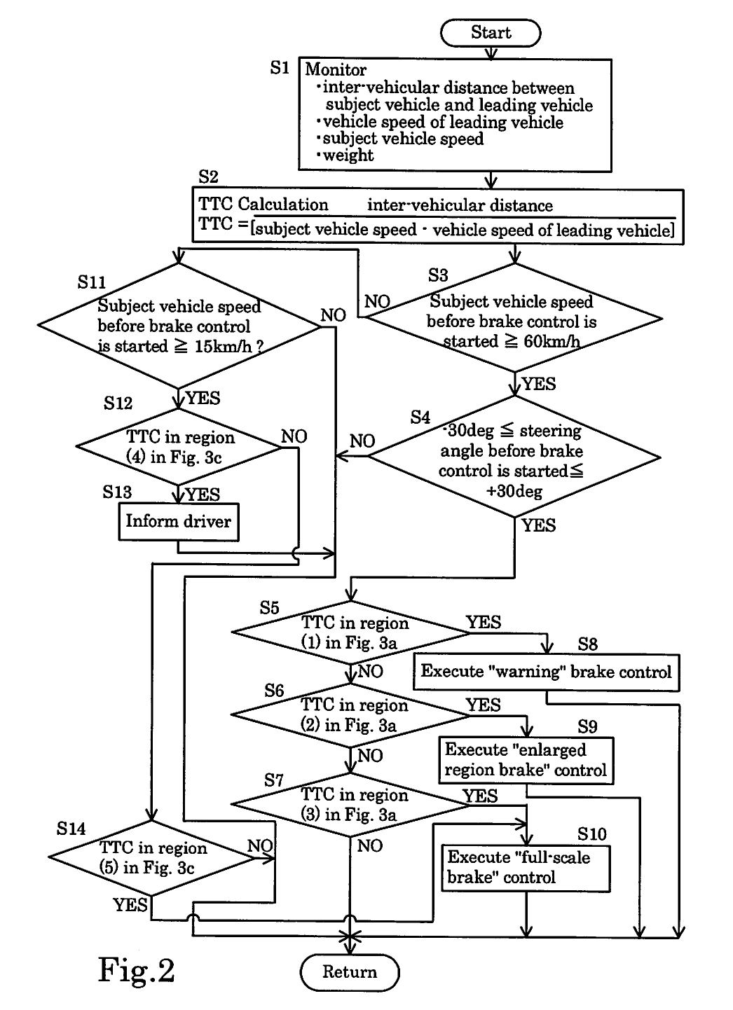

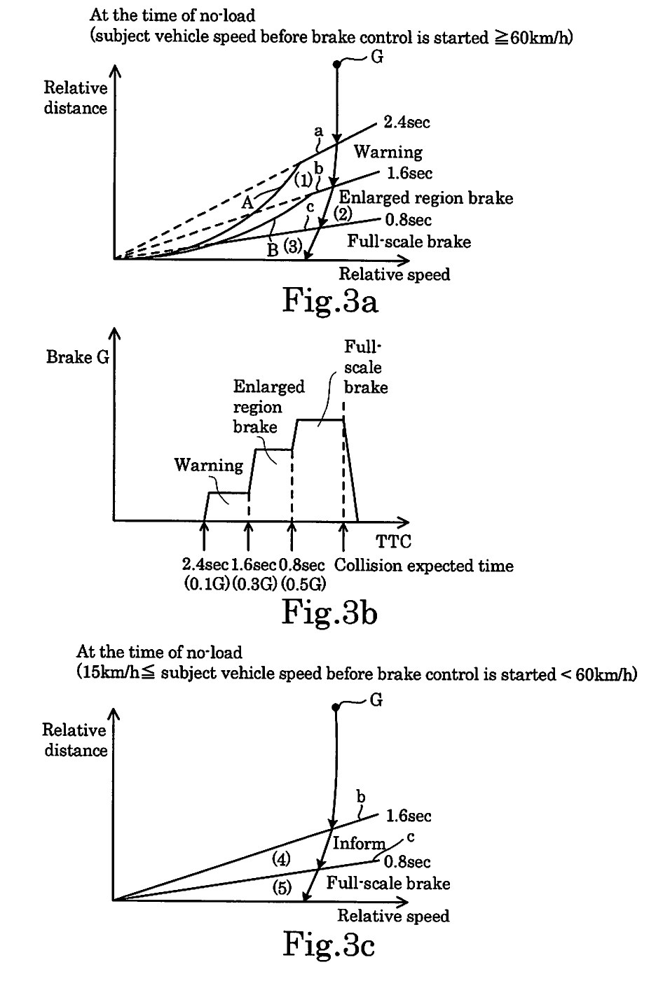

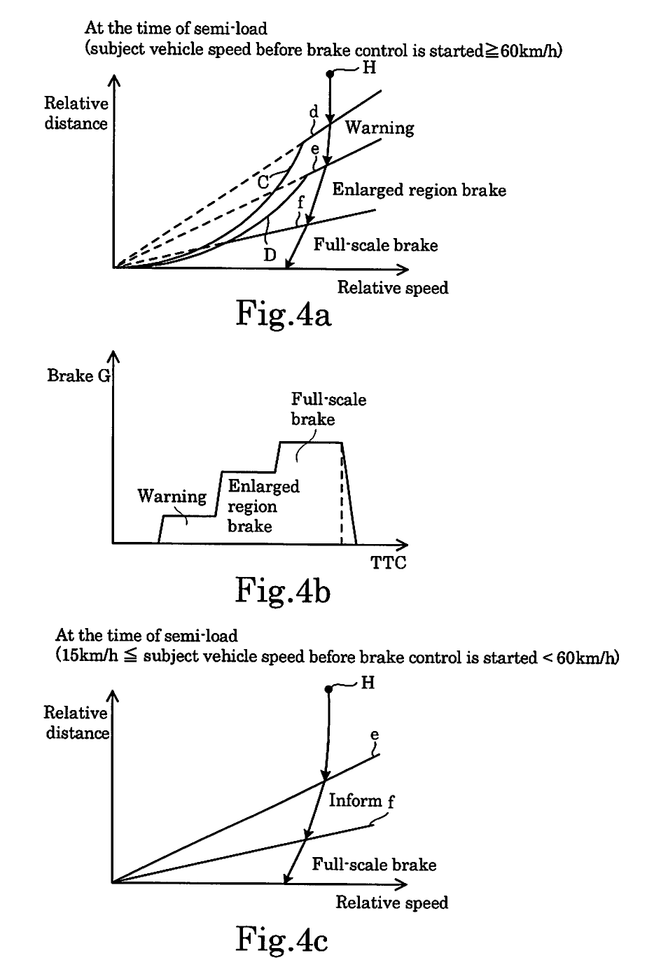

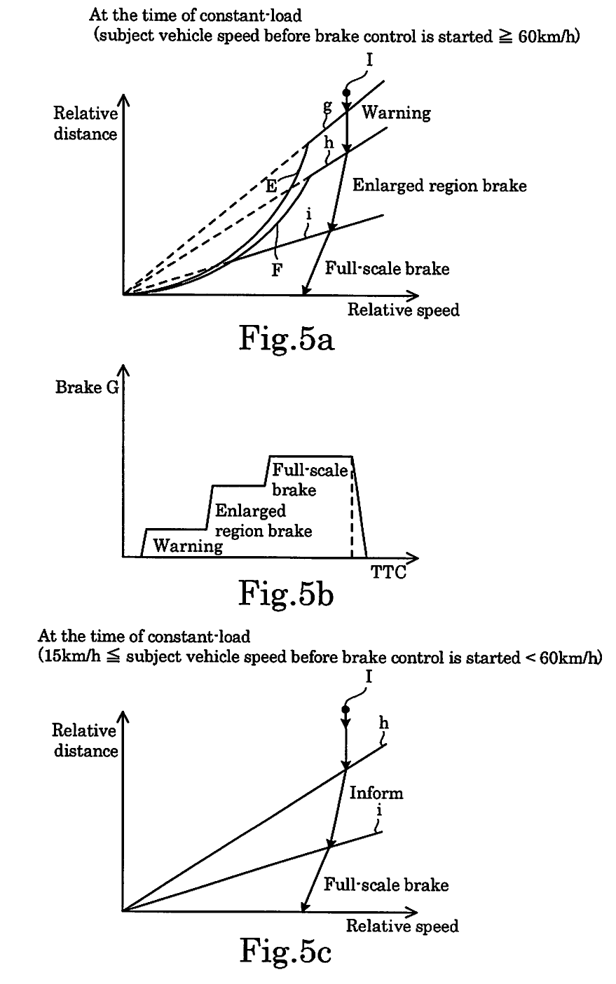

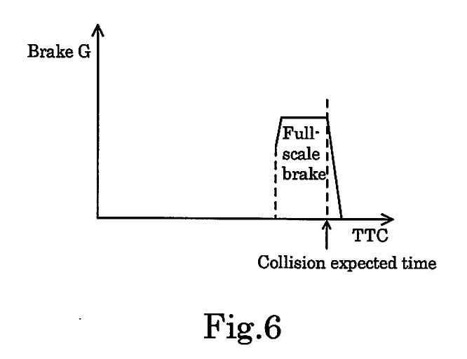

An automatic brake control device according to a first embodiment will be explained with reference to FIGS. 1 to 6. FIG. 1 is a configuration diagram of a control system according to the present embodiment. FIG. 2 is a flowchart showing operation of a brake control ECU (Electric Control Unit) according to the present embodiment. FIG. 3 are diagrams showing brake patterns of the brake control ECU of the present embodiment at the time of no-load. FIG. 4 are diagrams showing brake patterns of the brake control ECU of the present embodiment at the time of semi-load. FIG. 5 are diagrams showing brake patterns of the brake control ECU of the present embodiment at the time of constant-load. FIG. 6 is a diagram showing a brake pattern of the brake control ECU of the present embodiment at the time of full-scale.

As shown in FIG. 1, a brake control ECU 4, a gateway ECU 5, a meter ECU 6, an engine ECU 8, an axle load scale 9 and an EBS (Electric Breaking System)_ECU 10 are connected to each other through a vehicle CAN (J1939) 7.

A steering sensor 2, a yaw rate sensor 3 and a vehicle speed sensor 13 are connected to the vehicle CAN (J1939) 7 through the gateway ECU 5, respectively, and sensor information thereof is taken into the brake control ECU 4. The brake control is performed by driving a brake actuator 11 by the EBS_ECU 10. A brake command to the EBS_ECU 10 is carried out by the braking operation at a driver's seat (not shown) and the brake control ECU 4. Brake information including information of braking operation by a driver is output by the EBS_ECU 10 and taken into the brake control ECU 4. The engine ECU 8 performs fuel injection amount control of the engine 12 and other control of the engine. The injection amount control command to the engine ECU 8 is carried out by acceleration operation at the driver's seat. An alarm display and a buzzer sound output from the brake control ECU 4 are displayed on a display (not shown) at the driver's seat by the meter ECU 6. Since a control system related to steering operation other than the steering sensor 2 does not relate directly to the present invention, they are not illustrated.

As shown in FIG. 1, the present embodiment is an automatic brake control device including a millimeter wave radar 1 for measuring a distance between a subject vehicle and a vehicle ahead of the subject vehicle or an object such as a falling body, a steering sensor 2 for detecting a steering angle, a yaw rate sensor 3 for detecting a yaw rate, and a brake control ECU 4 which automatically performs brake control based on sensor output such as a vehicle speed sensor 13 which detects a subject vehicle speed even if there is no driving operation.

The present embodiment is characterized in that the brake control ECU 4 includes a stepwise brake control means which automatically performs stepwise brake control when TTC derived from a relative distance and a relative speed between the object and the subject vehicle obtained from the sensor output from the millimeter wave radar 1 and the vehicle speed sensor 13 is lower than a predetermined value.

This stepwise brake control means, as shown in FIG. 3b, includes brake control means which gradually increases a brake force in three stages in time series. In the example shown in FIG. 3b, at a first stage described as “alarm”, a brake force of about 0.1 G is applied from TTC 2.4 seconds to 1.6 seconds. At this stage, a so-called abrupt brake is not yet applied, a stop lamp is lit and it is possible to inform a vehicle behind of the fact that abrupt brake will be applied soon. Next, at a second stage described as “enlarged region brake”, a brake force of about 0.3 G is applied from TTC 1.6 seconds to 0.8 seconds. Lastly, at a third stage described as “full-scale brake”, the maximum brake force (about 0.5 G) is applied from TTC 0.8 seconds to 0 second.

When a driver performs a strong brake operation greater than the above-described brake force, the priority is given to the stronger brake force.

In the present embodiment, as shown in FIGS. 3 to 5, the brake control ECU 4 includes a brake pattern selecting portion 40 which changes a brake pattern in accordance with an onboard cargo or a weight of passengers. The brake pattern can be changed in such a manner that a plurality of control patterns “at the time of no-load”, “at the time of semi-load” and “at the time of constant-load” are previously stored in a brake pattern storing portion 41 of the brake control ECU 4, and the brake pattern selecting portion 40 selects a suitable brake pattern from the brake patterns in accordance with the weight. The weight information of the onboard cargo or the passenger is obtained by the axle load scale 9 shown in FIG. 1 and taken into the brake control ECU 4.

The following explanation is based on a vehicle ahead of the subject vehicle, but the automatic brake control device of the present embodiment is also effective for a falling body on a road.

The automatic brake control device includes means which prohibits actuation of the stepwise brake control means when the subject vehicle speed is less than 60 km/h and a steering angle is +30 degrees or greater or −30 degrees or less. A yaw rate may be used instead of the steering angle.

That is, the stepwise brake control performed by the automatic brake control device of the present embodiment is based on the assumption that it is used when a vehicle speed before the brake control is started is 60 km/h or more and a large steering operation such as lane changing or running on sharp curve is not carried out. Therefore, the actuation of the stepwise brake control in a running state other than above can be limited.

When the subject vehicle speed before the brake control is started is less than 60 km/h, since kinetic energy of the vehicle is small, no problem is caused even if simple abrupt brake control which is conventionally applied in passenger vehicles is carried out, usefulness for performing the stepwise brake control is low and thus, actuation of the stepwise brake control is limited. If a steering angle before the brake control is started is +30 degrees or greater or −30 degrees or less, since this means that the vehicle is changing a lane or running on a sharp curve, this is out of condition for applying the stepwise brake control, and actuation of the stepwise brake control is limited. In this case, a yaw rate may be used instead of the steering angle.

In the present embodiment, when the subject vehicle speed before the brake control is started is less than 60 km/h and 15 km/h (minimum speed at which usefulness of automatic brake control (only full-scale brake control) is recognized) or greater, the stepwise brake control is not carried out, but only the full-scale brake control shown in FIGS. 3b to 5b is carried out. When only the full-scale brake control is carried out, it is possible to apply the same brake control as the conventional automatic brake control used for passenger vehicles. When the same automatic brake control as that of the conventional technique is applied, a step for determining whether the subject vehicle is changing a lane or running on a sharp curve is unnecessary.

The performance of the automatic brake control device of the present embodiment will be explained with reference to a flowchart in FIG. 2. The explanation of FIG. 2 is based on a brake pattern at the time of no-load (FIG. 3), but performance at the time of semi-load (FIG. 4) or at the time of constant-load (FIG. 5) is also carried out in accordance with the flowchart in FIG. 2. As shown in FIG. 2, the millimeter wave radar 1 measures and monitors a distance between the subject vehicle and a vehicle ahead and the vehicle speed of the vehicle ahead. The vehicle speed sensor 13 measures and monitors the subject vehicle speed. The axle load scale 9 measures and monitors the weight of an onboard cargo and passengers (S1). The brake pattern selecting portion 40 of the brake control ECU 4 previously selects one of brake patterns (FIGS. 3 to 5) based on a result of measurement of the weight. An example in which the brake pattern in FIG. 3 is selected will be explained below.

Here, TTC is calculated by an inter-vehicular distance, a subject vehicle speed, and a vehicle speed of a leading vehicle (S2). The calculation method is inter-vehicular distance/(subject vehicle speed−vehicle speed of the leading vehicle). If a subject vehicle speed before the brake control is started is 60 km/h or greater (S3), and if a steering angle before the brake control is started is −30 degrees or less and +30 degrees or greater (S4), and if TTC is in a region (1) shown in FIG. 3a (S5), the “alarm” brake control is performed (S8). If TTC is in the region (2) shown in FIG. 3a (S6), the “enlarged region brake” control is performed (S9). If TTC is in the region (3) shown in FIG. 3a (S7), the “full-scale brake” control is performed (S10).

If the subject vehicle speed before the brake control is started is less than 60 km/h and 15 km/h or greater (S3, S11) and TTC is in a region (4) shown in FIG. 3c (S12), a driver is informed of the fact that a relative distance between the subject vehicle and the leading vehicle is short (S13). A driver is informed of this fact by means of alarm display or a buzzer sound. If the TTC is in a region (5) shown in FIG. 3c (S14), the “full-scale brake” control is performed (S10).

It is possible to utilize a yaw rate from the yaw rate sensor 3 instead of the steering angle from the steering sensor 2. Or both the steering angle and the yaw rate may be utilized.

Here, FIGS. 3 to 5 will be explained. Straight lines c, f and i in FIGS. 3 to 5 are called steering avoidance limit straight lines, and curves B, D and F in FIGS. 3 to 5 are called brake avoidance limit curves.

That is, the steering avoidance limit straight line is a straight line showing a limit to avoid collision by steering operation within predetermined TTC in a relation between one relative distance to an object and one relative speed with the object. The brake avoidance limit curve is a curve showing a limit to avoid collision by braking operation within a predetermined TTC in a relation between one relative distance to an object and one relative speed with respect to the object.

In FIGS. 3 to 5, in a region where both lower side regions of the straight line and curve are related, it is not possible to avoid collision by any of steering operation and braking operation.

In the example at the time of no-load in FIG. 3, TTC is set to 0.8 seconds in the straight line c. In the present embodiment, a straight line a when TTC is 2.4 seconds is provided on the upper side of the steering avoidance limit straight line c and a straight line b when TTC is 1.6 seconds is provided. A curve A in which TTC is set to 1.6 seconds is provided on the upper side of a brake avoidance limit curve B in which TTC is set to 0.8 seconds.

The initial state of the vehicle has a relative distance and a relative speed with respect to an object shown at the black point G in FIG. 3. When the subject vehicle speed before the brake control is started is 60 km/h or greater, the relative distance gradually becomes short, and when the relative distance comes to a position of the straight line a, the mode is brought into an alarm mode (region (1)). In the alarm mode, a brake force of about 0.1 G is applied to TTC 2.4 seconds to 1.6 seconds. In this period, the stop lamp is lit to inform a vehicle behind that a brake is applied. When the relative speed is reduced and it comes to a position of the straight line b, the mode is brought into an enlarged region brake mode (region (2)). In the enlarged region brake mode, a brake force of about 1.3 G is applied to TTC 1.6 seconds to 0.8 seconds. When it comes to a position of the straight line c, the mode is brought into a full-scale brake mode (region (3)). In the full-scale brake mode, the maximum brake force (about 0.5 G) is applied to TTC 0.8 seconds to 0 second. According to the calculation in step 2 in FIG. 2, a collision occurs. However, since the subject vehicle speed becomes small by the brake control in the actual case, the actual TTC becomes longer than the calculation result in step S2.

That is, according to the calculation of TTC in the automatic brake control device in the present invention, precise distance measurement and complicated calculating processing are omitted as much as possible, and a general simple distance measuring device (e.g., a millimeter wave radar) or a calculating device is used. Such consideration is effective for suppressing the producing cost and maintenance cost of a vehicle to low levels.

To be strict, the subject vehicle and a leading vehicle which is an object carry out uniform accelerated motion by braking (deceleration). Therefore, TTC must be calculated also based on the uniform accelerated motion, but TTC is calculated based on the assumption that simple uniform motion is carried out, thereby omitting precise distance measurement and complicated calculation.

By carrying out such calculation based on the assumption that the motion is the uniform motion, the calculated TTC value becomes smaller than the actual TTC, but this is an error on the safe side and thus, no problem occurs even if the error is permitted.

When the subject vehicle speed before the brake control is started is 15 km/h or greater and less than 60 km/h, the relative distance gradually becomes short, and when it comes to a position of the straight line b, the mode is brought into an informing mode (region (4)). In the informing mode, a driver is informed of the fact that the relative distance between the subject vehicle and the object becomes short by means of alarm display or a buzzer sound. When it comes to a position of the straight line c, the mode is brought into the full-scale brake mode (region (5)). In the full-scale brake mode, the maximum brake force (about 0.5 G) is applied to TTC 0.8 seconds to 0 second.

FIG. 4 show an example at the time of semi-load, and FIG. 5 show an example at the time of constant-load. Here, the equal brake forces are compared with each other, as the weight of onboard cargo or passenger is increased, the braking distance also becomes longer and thus, the steering avoidance limit straight line and the brake avoidance limit curve also move upward in the drawings. With this, areas of the regions (1), (2), (3), (4) and (5) are increased in accordance with the weight of the onboard cargo or passenger.

The straight lines a to c in FIG. 3 correspond to straight lines d to f in FIG. 4 and straight lines g to i in FIG. 5. Curves A and B in FIG. 3 correspond to curves C and D in FIG. 4 and curves E and F in FIG. 5. The black points G in FIG. 3 correspond to black points H in FIG. 4 and black points I in FIG. 5.

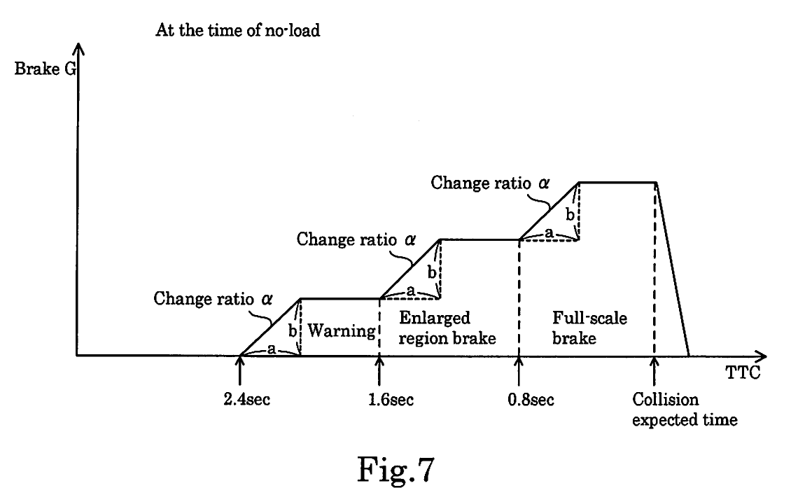

An automatic brake control device according to a second embodiment will be explained with reference to FIG. 7. The control system configuration diagram and the flowchart showing the control procedure of the brake control ECU are the same as those of the first embodiment (FIGS. 1 and 2). The present embodiment is characterized in that the brake control ECU 4 includes means which sets, to a predetermined value, a change ratio of a brake force in a section between rising points of brake forces of the “alarm” stage, the “enlarged region brake” stage and the “full-scale brake” stage as shown in FIG. 7.

In FIG. 7, a brake force change ratio is explained based on the automatic brake control pattern at the time of no-load shown in FIG. 3b in the first embodiment. In FIG. 7, expressions 2.4 seconds, 1.6 seconds and 0.8 seconds are TTC. In the present embodiment, as shown in FIG. 7, the brake force is increased by the change ratio α=b(G)/a (second) in a section from the rising points (2.4 seconds, 1.6 seconds and 0.8 seconds) of the stages to a predetermined brake force. The change ratio α is an appropriate value which is previously obtained test running or simulation so that the change ratio of the brake force falls within a permissible range in which the attitude variation of the vehicle does not become unstable. Concrete numeric value is varied due to difference in type of vehicle such as bus and truck and thus, such value is not indicated. The same change ratios α are used in the various stages also in FIG. 5 (at the time of semi-load) and FIG. 6 (at the time of constant-load).

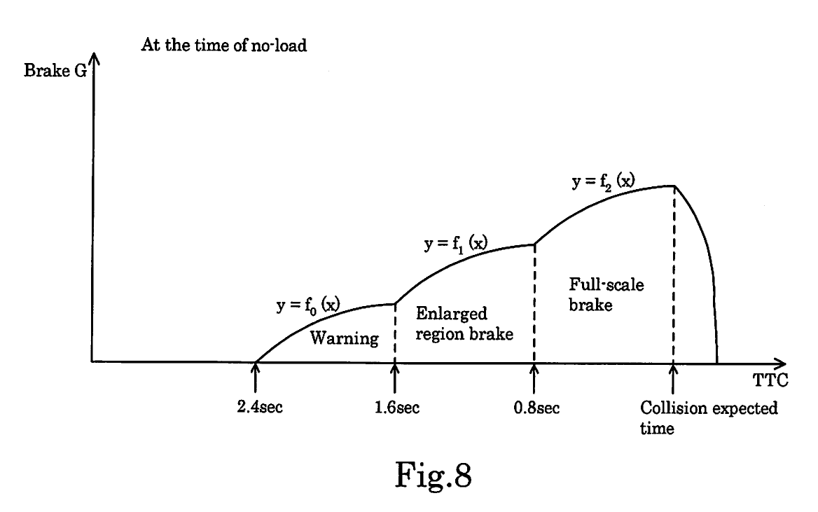

A third embodiment will be explained with reference to FIG. 8. FIG. 8 is a diagram for explaining a brake force change curve in a brake pattern. In the present embodiment, as shown in FIG. 8, the brake control ECU 4 includes means which brings a variation process of a brake force in a section from the rising points of brake forces in the various stages to the predetermined brake force to a variation process along the curve shape defined by a predetermined function.

That is, in the “alarm” region, the variation process of the brake force is a variation process along a curve shape defined by a function y=f₀(X). In the “enlarged region brake” region, the variation process of the brake force is a variation process along the curve shape defined by a function y=f₁(X). In the “full-scale brake” region, the variation process of the brake force is a variation process along the curve shape defined by a function y=f₂(X)

Since these functions replace the straight brake force variation in the brake pattern shown in FIG. 7 by a smooth curve brake force variation, appropriate functions are previously obtained by simulation or test running for vehicle type, at the time of no-load, at the time of semi-load and at the time of constant-load. FIG. 8 shows a brake pattern at the time of no-load, but brake patterns are also determined for a value at the time of semi-load and for a value at the time of constant-load.

According to the third embodiment, the brake force variation is smoother as compared with the second embodiment.

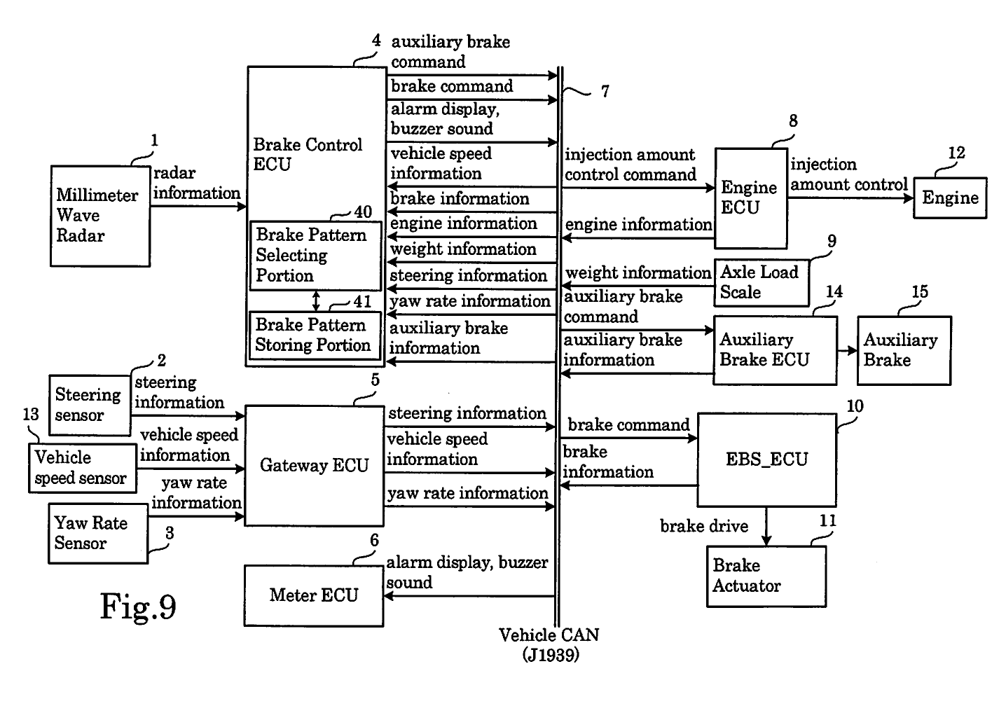

An automatic brake control device according to a fourth embodiment will be explained with reference to FIG. 9. FIG. 9 is a control system configuration diagram of the present embodiment. The flowchart showing the performance of the brake control ECU of the present embodiment is the same as that of the first embodiment (FIG. 2).

As shown in FIG. 9, a brake control ECU 4, a gateway ECU 5, a meter ECU 6, an engine ECU 8, an axle load scale 9, an EBS (Electric Breaking System)□ECU 10, and an auxiliary brake ECU 14 are connected to each other through a vehicle CAN (J1939) 7.

A steering sensor 2, a yaw rate sensor 3 and a vehicle speed sensor 13 are connected to the Vehicle CAN (J1939) 7 through the gateway ECU 5, respectively, and sensor information thereof is taken into the brake control ECU 4. The brake control is performed by driving a brake actuator 11 by the EBS_ECU 10. A brake command to the EBS_ECU 10 is carried out by the braking operation at a driver's seat (not shown) and the brake control ECU 4. Brake information including information of braking operation by a driver is output by the EBS_ECU 10 and taken into the brake control ECU 4.

The auxiliary brake 15 is controlled if the auxiliary brake ECU 14 drives the auxiliary brake 15. An auxiliary brake command is sent to the auxiliary brake ECU 14 by the auxiliary brake operation and the brake control ECU 4 at the driver's seat (not shown). The auxiliary brake ECU 14 outputs the auxiliary brake information including information of the auxiliary brake operation by the driver, and the auxiliary brake information is taken into the brake control ECU 4.

The engine ECU 8 performs fuel injection amount control of the engine 12 and other control of the engine. The injection amount control command to the engine ECU 8 is carried out by acceleration operation at the driver's seat. A alarm display or a buzzer sound output from the brake control ECU 4 are displayed on a display (not shown) at the driver's seat by the meter ECU 6. Since a control system related to steering operation other than the steering sensor 2 does not relate directly to the present invention, they are not illustrated.

The present embodiment is characterized in that the stepwise brake control means includes brake control means which gradually increases a brake force in a plurality of stages in time series as shown in FIG. 3b, and includes the auxiliary brake ECU 14 which generates a brake force by the auxiliary brake 15 in a first stage described as “alarm” in which the brake force is a predetermined value or less. Here, the auxiliary brake 15 is an electromagnetic retarder, an engine retarder, an exhaust brake, an air brake (trailer) or the like.

According to the current provision of law, it is regulated that “brake by an auxiliary brake should be applied at 0.2 G or less”, but in the first stage described as the “alarm”, since a brake force of about 0.1 G is used, it is appropriate that a brake force is generated by the auxiliary brake 14.

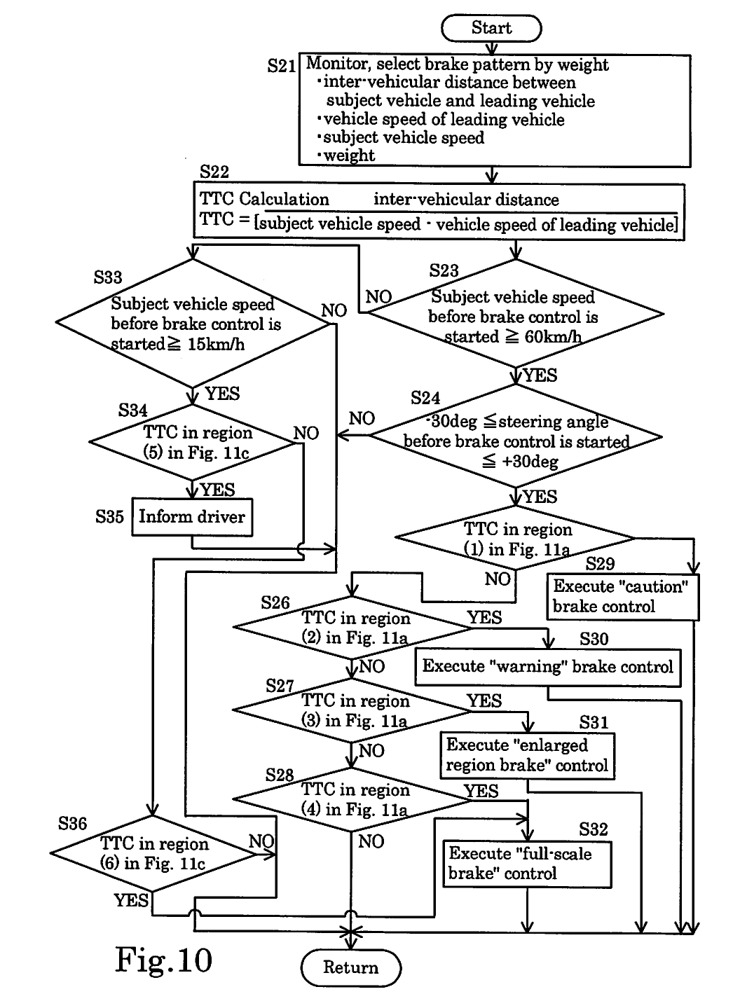

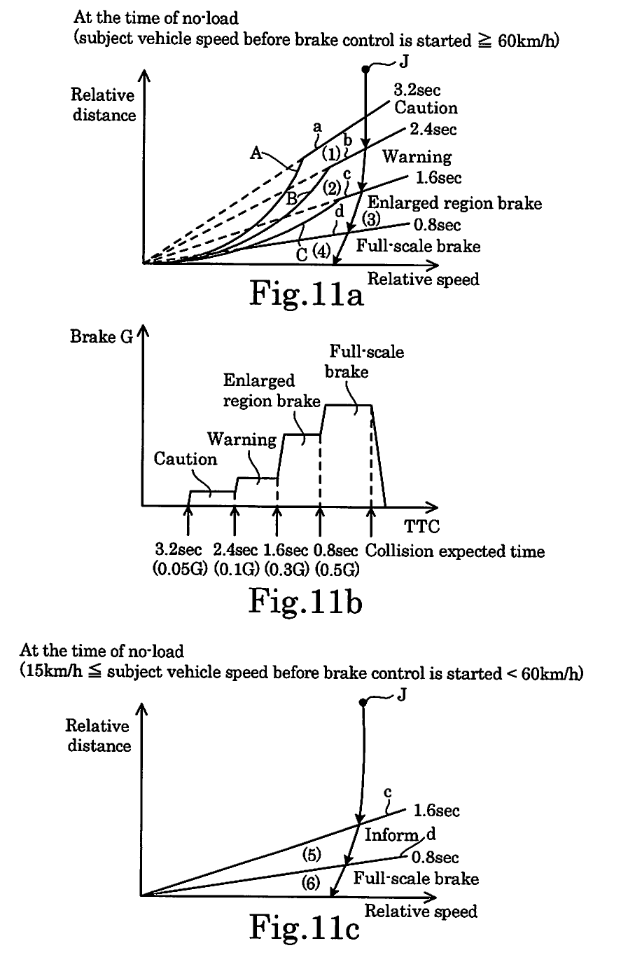

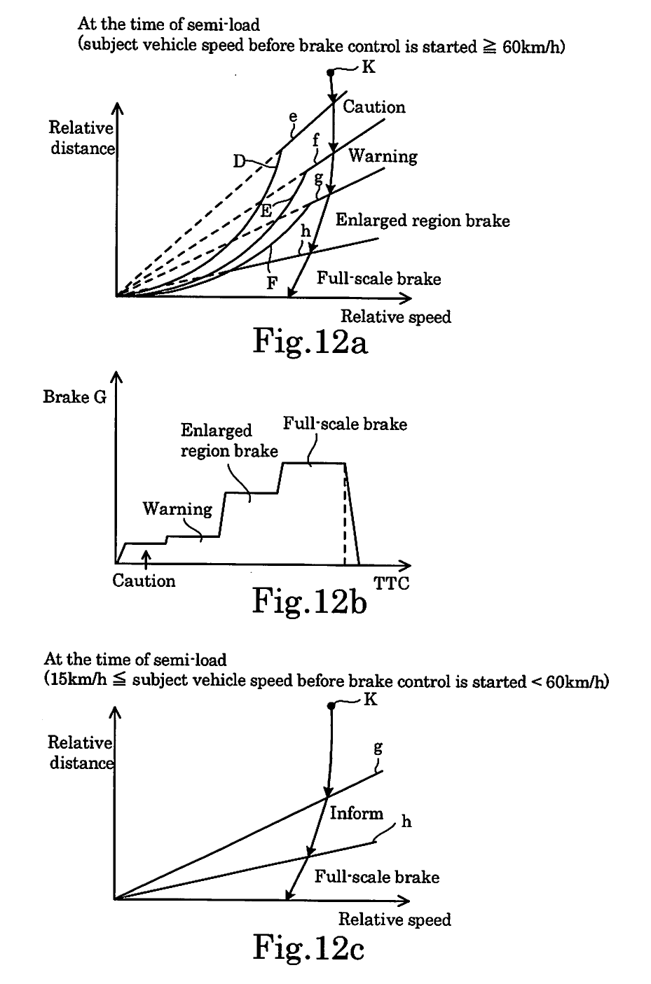

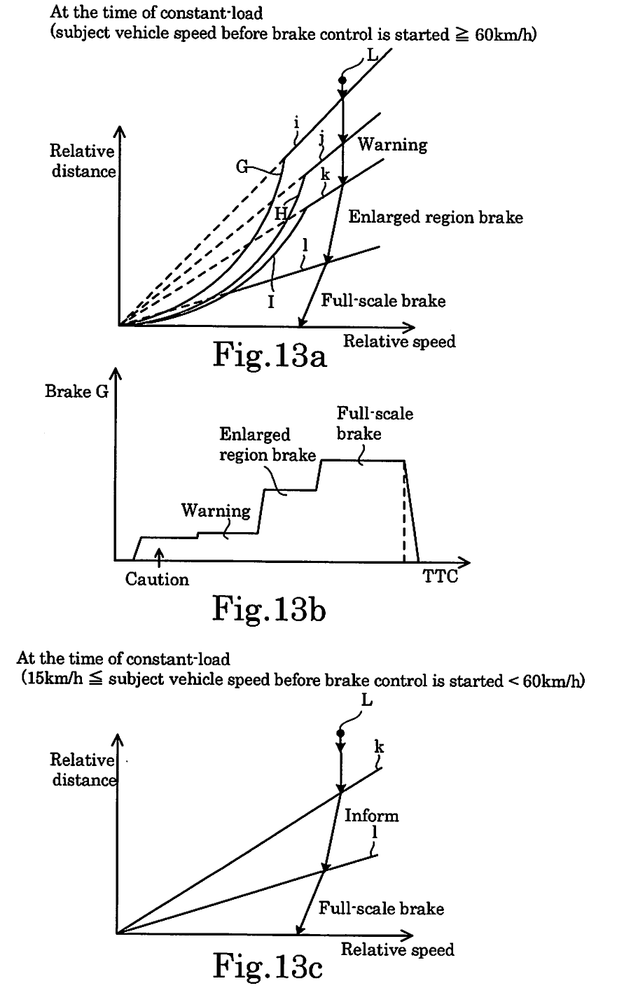

An automatic brake control device of a fifth embodiment will be explained with reference to FIGS. 9 to 13. The control system configuration of the fifth embodiment is the same as that of the fourth embodiment (FIG. 9). FIG. 10 is a flowchart showing control procedure of a brake control ECU of the present embodiment. FIG. 11 are diagrams showing brake patterns of the brake control ECU of the present embodiment at the time of no-load. FIG. 12 are diagrams showing brake patterns of the brake control ECU of the present embodiment at the time of semi-load. FIG. 13 are diagrams showing brake patterns of the brake control ECU of the present embodiment at the time of constant-load.

The present embodiment is characterized in that the brake control ECU 4 further is provided a caution stage having a smaller brake force or brake reduction speed than the alarm stage at a forward stage than the alarm stage which is the first stage of the three stages explained in the first to fourth embodiments. The caution stage performs brake operation using the auxiliary brake 15.

In the example shown in FIG. 11b, a brake force of about 0.05 G is applied from TTC 3.2 seconds to 2.4 seconds using the auxiliary brake 15 at the first state described as “caution”. This stage is a state where a gentle brake is applied by the auxiliary brake 15, and has a function of cautioning for a driver. That is, the auxiliary brake 15 is operated, a driver hears a sound emitting from the auxiliary brake itself, a sound emitting from the engine because the engine revolution number is reduced, or an alarm sound informing the driver of the fact that the automatic brake control is actuated, recognizes that the automatic brake control is actuated by feeling the deceleration, and can pay attention to the leading vehicle. Stages thereafter (alarm, enlarged region brake, full-scale brake) are the same as those explained in the first embodiment.

The performance of the automatic brake control device of the present embodiment will be explained with reference to a flowchart shown in FIG. 10. The explanation of FIG. 10 is based on a brake pattern at the time of no-load (FIG. 11), but performance at the time of semi-load (FIG. 12) or at the time of constant-load (FIG. 13) is also carried out in accordance with the flowchart in FIG. 10. As shown in FIG. 10, the brake control ECU 4 measures and monitors the inter-vehicular distance between the subject vehicle and the leading vehicle and a vehicle speed of the leading vehicle by means of the millimeter wave radar 1. Further, the vehicle speed sensor 13 measures and monitors the subject vehicle speed. The axle load scale 9 measures and monitors the weight of the onboard cargo and passenger. The brake pattern selecting portion 40 of the brake control ECU 4 previously selects any of brake patterns (FIGS. 3 to 5) based on the measuring result of the weight (S21). The following explanation is based on an example in which the brake pattern in FIG. 11 is selected.

Then, the brake control ECU 4 calculates TTC by the inter-vehicular distance, the subject vehicle speed and the vehicle speed of the leading vehicle (S22). The calculation method is as explained above. If a subject vehicle speed before the brake control is started is 60 km/h or greater (S23), and if a steering angle before the brake control is started is +30 degrees or less and −30 degrees or greater (S24), and if TTC is in a region (1) shown in FIG. 11a (S25), the brake control ECU 4 performs the “caution” brake control (S29). If TTC is in the region (2) shown in FIG. 11a (S26), the “alarm” brake control is performed (S30). If TTC is in the region (3) shown in FIG. 11a (S27), the “enlarged region brake” control is performed (S31). Further, if TTC is in the region (4) shown in FIG. 11a (S28), the “full-scale brake” control is performed (S32).

If the subject vehicle speed before the brake control is started is less than 60 km/h and 15 km/h or greater (S23, S33) and TTC is in a region (5) shown in FIG. 11c (S34), the brake control ECU 4 informs a driver of the fact that a relative distance between the subject vehicle and the leading vehicle is short (S35). A driver is informed of this fact by means of alarm display or a buzzer sound. If the TTC is in a region (6) shown in FIG. 11c (S36), the “full-scale brake” control is performed (S32).

It is possible to utilize a yaw rate from the yaw rate sensor 3 instead of the steering angle from the steering sensor 2. Or both the steering angle and the yaw rate may be utilized.

Here, FIGS. 11 to 13 will be explained. Straight lines d, h and l in FIGS. 11 to 13 are steering avoidance limit straight lines, and curves C, F and I in FIGS. 11 to 13 are brake avoidance limit curves. For example, in the example at the time of no-load in FIG. 11, TTC is set to 0.8 seconds in the straight line d. In the present embodiment, a straight line c when TTC is 1.6 seconds is provided on the upper side of the steering avoidance limit straight line d, a straight line b when TTC is 2.4 seconds is provided, and a straight line a when TTC is 3.2 seconds is provided. A curve B in which TTC is set to 1.6 seconds is provided on the upper side of the brake avoidance limit curve C in which TTC is set to 0.8 seconds, and a curve A in which TTC is set to 2.4 seconds is provided.

The initial state of the vehicle has a relative distance and a relative speed with respect to an object shown at the black point J in FIG. 11. When the subject vehicle speed before the brake control is started is 60 km/h or greater, the relative distance gradually becomes short, and when the relative distance comes to a position of the straight line a, the mode is brought into a caution mode (region (1)). In the caution mode, a brake force of about 0.05 G is applied to TTC 3.2 seconds to 2.4 seconds. In this period, gentle brake is applied by the auxiliary brake 14 to urge a driver to pay attention to the leading vehicle.

When the relative distance gradually becomes short and comes to the position of the straight line b, the mode is brought into the alarm mode (region (2)). In the alarm mode, a brake force of about 0.1 G is applied to TTC 2.4 seconds to 1.6 seconds. In this period, a stop lamp is lit to inform a vehicle behind of the fact that brake will be applied. Further, when the relative speed is reduced and comes to the position of the straight line c, the mode is brought into the enlarged region brake mode (region (3)).

In the enlarged region brake mode, a brake force of about 0.3 G is applied to TTC 1.6 seconds to 0.8 seconds. When the line comes to the position of the straight line d, the mode is brought into the full-scale brake mode (region (4)). In the full-scale brake mode, the maximum brake force (about 0.5 G) is applied to TTC 0.8 seconds to 0 second. According to the calculation in step 22 in FIG. 10, a collision occurs. However, since the actual TTC is longer than the calculation result in step S22. The reason is as described in the first embodiment.

When the subject vehicle speed before the brake control is started is 15 km/h or greater and less than 60 km/h, the relative distance gradually becomes short, and when it comes to the position of the straight line c, the mode is brought into the informing mode (region (5)). In the informing mode, a driver is informed of the fact that the relative distance with respect to the object becomes short by means of alarm display or a buzzer sound. When the line comes to the position of the straight line d, the mode is brought into the full-scale brake mode (region (6)). In the full-scale brake mode, the maximum brake force (about 0.5 G) is applied to TTC 0.8 seconds to 0 second.

FIG. 12 show an example at the time of semi-load, and FIG. 13 show an example at the time of constant-load. If the equal brake forces are compared with each other, as the weight of onboard cargo or passenger is increased, the braking distance also becomes longer and thus, the steering avoidance limit straight line and the brake avoidance limit curve also move upward in the drawings. With this, areas of the regions (1), (2), (3), (4), (5) and (6) are increased in accordance with the weight of the onboard cargo or passenger.

The straight lines a to d in FIG. 11 correspond to straight lines e to h in FIG. 12 and straight lines i to l in FIG. 13. Curves A, B and C in FIG. 11 correspond to curves D, E and F in FIG. 12 and curves G, H and I in FIG. 13. The black points I in FIG. 11 correspond to black points J in FIG. 12 and black points L in FIG. 13.

### INDUSTRIAL APPLICABILITY

According to the present invention, it is possible to realize an automatic brake control in a truck and a bus, and to contribute traffic safety. Especially, it is possible to reduce a load on a disk brake by using an auxiliary brake at an initial stage of the automatic brake control. It is possible to secure high safety by providing a caution stage.

1. An automatic brake control device comprising control means which automatically performs brake control based on a sensor output including a distance between a subject vehicle and an object existing ahead the subject vehicle even if there is no driving operation, wherein
the control means includes stepwise brake control means which automatically performs stepwise brake control when an estimated value of time elapsed until a distance between the object and the subject vehicle derived based on a relative distance and a relative speed of the object and the subject vehicle obtained by the sensor output becomes a predetermined distance or less becomes less than a predetermined value.

2. The automatic brake control device according to claim 1, wherein the stepwise brake control means includes brake control means which gradually increases the brake force or a brake reduction speed over a plurality of stages in time series.

3. The automatic brake control device according to claim 1, wherein the stepwise brake control means includes means which sets, to a predetermined value, a change ratio of the brake force or a brake reduction speed in a section from a rising point of the brake force or the brake reduction speed of each stage to a point in which intended brake force or brake reduction speed is achieved.

4. The automatic brake control device according to claim 1, wherein the stepwise brake control means includes means which brings, into variation process along a curve shape defined by a predetermined function, a variation process of a brake force or brake reduction speed in a section from a rising point of the brake force or the brake reduction speed of each stage to a point in which intended brake force or brake reduction speed is achieved.

5. The automatic brake control device according to claim 1, wherein the stepwise brake control means includes means which generates a brake force by an auxiliary brake in a stage where the brake force or the brake reduction speed is a predetermined value or less.

6. The automatic brake control device according to claim 1, wherein the stepwise brake control means includes a caution stage having a brake force or a brake reduction speed smaller than that of the initial stage, and the stepwise brake control means is provided with the caution stage at its stage forward than the initial stage of the plurality of stages.

7. The automatic brake control device according to claim 6, wherein in the caution stage, brake is executed using the auxiliary brake.

8. The automatic brake control device according to claim 1, comprising means which prohibits actuation of the stepwise brake control means when the subject vehicle speed is less than a predetermined value and a value of the steering angle or a yaw rate is out of a predetermined range.
